(19) United States
(12) Patent Application Publication
(10) Pub. No.: US 2007/0021516 A1
(43) Pub. Date: Jan. 25, 2007

(54) Halogen-free, flame-retardant polyurethane foams

(75) Inventors: Jan-Gerd Hansel, Koln (DE); Heiko Tebbe, Dormagen (DE); Hans Dahmen, Koln (DE)

Correspondence Address: LANXESS CORPORATION, 111 RIDC PARK WEST DRIVE, PITTSBURGH, PA, 15275-1112, US

(73) Assignee: LANXESS Deutschland GmbH

(21) Appl. No.: 11/488,231

(22) Filed: Jul. 18, 2006

(30) Foreign Application Priority Data
Jul. 22, 2005 (DE) 10 2005 034 269.8

(51) Int. Cl. C08J 9/00

(52) U.S. Cl. 521/99

(57) ABSTRACT

The present invention relates to flame-retardant polyurethane foams which comprise, as flame retardant, halogen-free bisphosphates free from hydroxy groups.

This application claims the benefit of German Application No. 10 2005 034 269.8 filed Jul. 22, 2005.

The present invention relates to flame-retardant polyurethane foams which comprise, as flame retardant, halogen-free tetraalkyl bisphosphates, and also to a process for production of these foams, and to their uses.

### BACKGROUND OF THE INVENTION

Polyurethane foams are plastics used in many sectors, such as furniture, mattresses, transport, construction and technical insulation. In order to meet stringent flame retardancy requirements, for example those demanded for materials in sectors such as the automotive sector, railway sector and aircraft-interior-equipment sector, and also for insulation in buildings, polyurethane foams generally have to be modified with flame retardants. A wide variety of different flame retardants is known for this purpose and is commercially available. However, their use is complicated by a wide variety of considerable application-related problems or toxicological concerns.

For example, when solid flame retardants, e.g. melamine, ammonium polyphosphate and ammonium sulphate are used technical problems of metering arise and often necessitate modifications to the foaming systems, i.e. complicated reconstruction and adaptation measures.

The frequently used flame retardants tris(chloroethyl)phosphate (molar mass 285 g/mol) and tris(chloroisopropyl)phosphate (molar mass 327 g/mol) are liquids that are easy to meter. However, an increasing requirement recently placed on open-cell flexible polyurethane foam systems for automobile-interior equipment is that the gaseous emissions (Volatile Organic Compounds, VOCs), and especially the condensable emissions (fogging) from these foams are not to exceed low threshold values. The abovementioned liquids now fail to meet these requirements because they have relatively low molar masses and consequently excessive volatility.

Fogging is the undesired condensation of vaporized volatile constituents on interior equipment of a motor vehicle on panes of glass, in particular on the windscreen. DIN 75 201 permits quantitative assessment of this phenomenon. A typical requirement of the automobile industry is that fogging condensate is permitted to be less than 1 mg by the DIN 75201 B method.

Tris(2,3-dichloroisopropyl)phosphate is likewise liquid and, with molar mass of 431 g/mol, has volatility sufficiently low to permit achievement of good fogging values. However, halogen-free flame retardant systems are frequently preferred for reasons of environmental toxicology and also for reasons of better side-effects in the event of a fire, in relation to smoke density and smoke toxicity. Halogen-free flame retardants can also be of particular interest for application-related reasons. For example, when halogenated flame retardants are used severe corrosion phenomena are observed on the plant components used for flame lamination of polyurethane foams. This can be attributed to the hydrohalic acid emissions arising during the flame lamination of halogen-containing polyurethane foams.

Flame lamination is the term used for a process for the bonding of textiles and foams by using a flame for incipient melting of one side of a foam sheet and then immediately pressing a textile web onto this side.

The halogen-free liquid flame retardant systems known hitherto, e.g. triethyl phosphate or other alkyl or aryl phosphates, such as diphenyl cresyl phosphate, give only inadequate compliance with the abovementioned requirements for very low levels of VOCs or very low levels of fogging, or exhibit inadequate flame retardancy.

In JP 2004339409 A2 and JP 2004352773 A2, tetraethyl ethylene glycol 1,2-diphosphate is described as flame retardant for polyurethane foams. Its very low molar mass of 334 g/mol makes it too volatile to permit a very low level of fogging.

Obvious methods of achieving low fogging values use hydroxy-bearing, reactive phosphates (DE-A 43 42 972) or phosphonates (DE-C 199 27 548). These react with the polyisocyanate used for foam production and are thus incorporated into the polyurethane. They therefore give very low fogging values. However, their processing is difficult because they disrupt the isocyanate reactions during the foaming process. The foam quality of a polyurethane foam depends on matching of the catalyst system to the competing reactions of the polyisocyanates with the polyols and, if appropriate, with the water. If then another reactive component is introduced, with a hydroxy-bearing flame retardant, the result can be production defects, such as shrinkage or cracks. The catalyst system, which is often composed of two or more components, then has to be matched to the reactivity of the flame retardant, while taking into account the stabilizers used, blowing agents, cell regulators, and, if appropriate, other constituents. This matching necessitates time-consuming development work. Furthermore, an additional amount of polyisocyanate has to be used, and this is undesirable for economic reasons.

U.S. Pat. No. 2,782,128 describes the application of tetraalkyl esters of aliphatic bisphosphoric acids, e.g. diethylene glycol bis(dipropyl phosphate) or 1,4-butylene glycol bis(dipropyl phosphate) as plasticizers for cellulose acetate.

U.S. Pat. No. 4,056,480 describes the application of tetraalkyl esters of aliphatic bisphosphoric acids, e.g. diethylene glycol bis(dibutyl phosphate) as hydraulic fluids.

### SUMMARY OF THE INVENTION

It is an object of the present invention to provide halogen-free flame-retardant polyurethane foams with low fogging which comprise flame retardants that are simple to process.

This object is achieved via flame-retardant polyurethane foams which comprise, as flame retardant, halogen-free tetraalkyl bisphosphates which are free from hydoxy groups and whose molar mass is at least 350 g/mol.

The term “halogen-free” means that the tetraalkyl bisphosphates do not comprie the elements fluorine, chlorine, bromine and/or iodine. The term “free from hydroxy groups” means that the tetraalkyl bisphosphates bear no OH groups bonded to carbon atoms. The term “tetraalkyl bisphosphates” indicates organic substances which contain two phosphoric ester groups-O—P(═O)(OR)₂ per molecule, where R is generally alkyl radicals and the alkyl radicals R present in a molecule may be identical or different.

The inventive polyurethane foams preferably comprise tetraalkyl bisphosphates of the general formula (I) 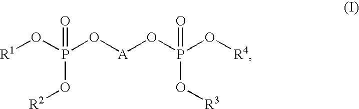
in which
R¹, R², R³, and R⁴, independently of one another, are a C₁-C₈-alkyl radical or C₁-C₄-alkoxyethyl radical,
A is a straight-chain, branched and/or cyclic C₄-C₂₀-alkylene radical, a —CH₂—CH═CH—CH₂-group, a —CH₂—C≡C—CH₂— group, or a —CHR⁵—CHR⁶—(O—CHR⁷—CHR⁸)ₐ— group, in which a is a number from 1 to 5, or a —CHR⁵—CHR⁶—S(O)_{b}—CHR⁷—CHR⁸— group, in which b is a number from 0 to 2, or a —(CHR⁵—CHR⁶)_{c}—O—R⁹—O—(CHR⁷—CHR⁸)_{d}— group, in which c and d, independently of one another, are numbers from 1 to 5,
R⁵, R⁶, R⁷, and R⁸, independently of one another, are H or methyl,
R⁹ is a —CH₂—CH═CH—CH₂— group, a —CH₂—C≡C—CH₂— group, a 1,2-phenylene radical, a 1,3-phenylene radical, a 1,4-phenylene radical, a radical of the general formula (II), 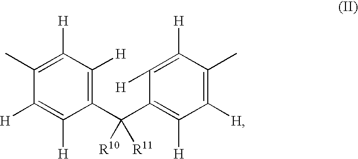
   or a radical of the general formula (III), 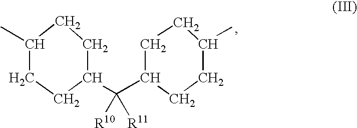
   or a radical of the general formula (IV), 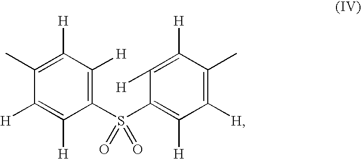
   or a radical of the formula —C(═O)—R¹²—C(═O)—,
R¹⁰ and R¹¹, independently of one another, are H or C₁-C₄-alkyl, or R¹⁰ and R¹¹ together are an optionally alkyl-substituted ring having from 4 to 8 carbon atoms, and
R¹² is a straight-chain, branched and/or cyclic C₂-C₈-alkylene radical, a 1,2-phenylene radical, a 1,3-phenylene radical, or a 1,4-phenylene radical.

In another particularly preferred embodiment, R¹, R², R³ and R⁴ are identical and are either ethyl, n-propyl, isopropyl, n-butyl or n-butoxyethyl.

In one particularly preferred embodiment, A is a straight-chain C₄-C₆-alkylene radical, or likewise a group of the general formula (III) 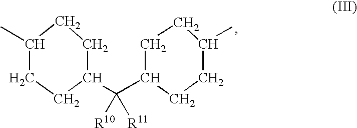
in which
R¹⁰ and R¹¹ are identical and are methyl, or a group of the formulae (V), (VI) or (VII), 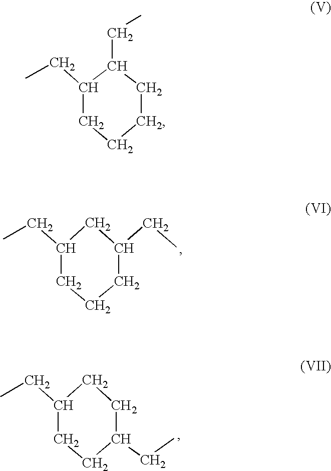
   or A is a —CHR⁵—CHR⁶—(O—CHR⁷—CHR⁸)ₐ— group, in which a is a number from 1 to 2 and R⁵, R⁶, R⁷ and R⁸ are identical and are H, or A is a —(CHR⁵—CHR⁶)_{c}—O—R⁹—O—(CHR⁷—CHR⁸)_{d}— group, in which c and d, independently of one another, are a number from 1 to 2, R⁹ is a group of the general formula (II) and R¹⁰ and R¹¹ are identical and are methyl.

In particular, it is particularly preferable that the inventive polyurethane foams comprise one or more of the tetraalkyl bisphosphates of the following specific formulae (VIII) to (XII):

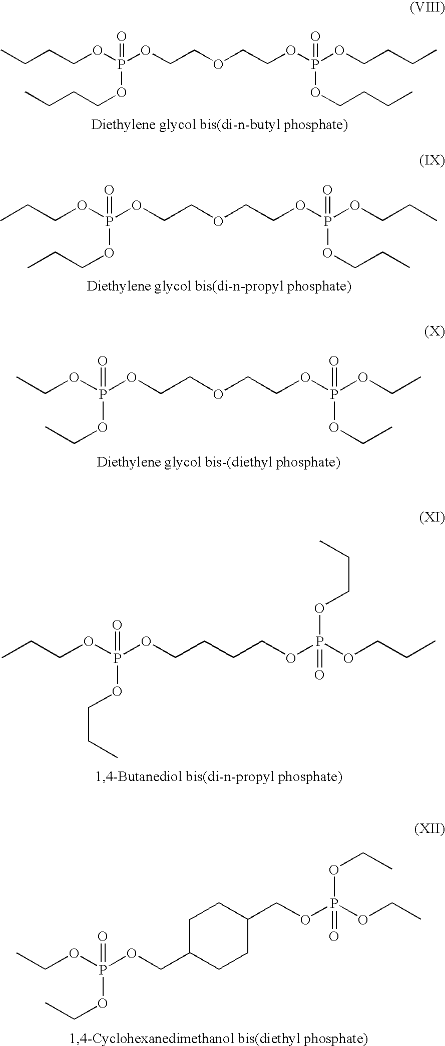

The tetraalkyl bisphosphates of the general formula (I) are preferably compounds that are liquid at processing temperatures. The processing temperature here is the temperature at which the polyurethane raw materials are fed to the metering and mixing assemblies of the foaming systems. Temperatures selected here are generally from 15 to 90° C., preferably from 20 to 80° C., as a function of the viscosities of the components and the design of the metering assemblies.

The tetraalkyl bisphosphates to be used according to the invention preferably have low volatility. This means that the volatility of the tetraalkyl bisphosphates to be used according to the invention is lower than the volatility of tris(chloroisopropyl)phosphate.

The tetraalkyl bisphosphates to be used according to the invention are preferably not reactive towards other starting materials used for production of polyurethane foams, in particular towards isocyanates. This statement refers to the reactivity explained above of flame retardants towards isocyanates.

The inventive, flame-retardant polyurethane foams are produced by reacting organic polyisocyanates with compounds having at least two hydrogen atoms reactive towards isocyanates, with conventional blowing agents, stabilizers, activators, and/or other conventional auxiliaries and additives, in the presence of halogen-free tetraalkyl bisphosphates free from hydroxy groups.

The amount used of the tetraalkyl bisphosphate is from 0.5 to 30 parts, preferably from 3 to 25 parts, based on 100 parts of polyol components.

The polyurethane foams are foams based on isocyanate and preferably having predominantly urethane groups and/or isocyanurate groups and/or allophanate groups and/or uretdione groups and/or urea groups and/or carbodiimide groups. The production of foams based on isocyanate is known and is described by way of example in DE-A 16 94 142, DE-A 16 94 215 and DE-A 17 20 768 and also in Kunststoff-Handbuch [Plastics handbook] Volume VII, Polyurethane [Polyurethanes], edited by G. Oertel, Carl-Hanser-Verlag Munich, Vienna 1993.
Polyurethane foams are broadly divided into flexible and rigid foams. Although flexible and rigid foams can in principle have approximately the same envelope density and constitution, flexible polyurethane foams have only a very low degree of crosslinking and have only a very low resistance to deformation under pressure. In contrast to this, the structure of rigid polyurethane foams is composed of high crosslinked units, and rigid polyurethane foam has very high resistance to deformation under pressure. The typical rigid polyurethane foam is of closed-cell type and has a low coefficient of thermal conductivity. In the production of polyurethanes, which proceeds by way of the reaction of polyols with isocyanates, the subsequent structure of the foam and its properties are influenced primarily by way of the structure and molar mass of the polyol and also by way of the reactivity and number (functionality) of the hydroxy groups present in the polyol. Further details concerning rigid and flexible foams and the starting materials that can be used for their production, and also concerning processes for their production, are found in Norbert Adam, Geza Avar, Herbert Blankenheim, Wolfgang Friederichs, Manfred Giersig, Eckehard Weigand, Michael Halfmann, Friedrich-Wilhelm Wittbecker, Donald-Richard Larimer, Udo Maier, Sven Meyer-Ahrens, Karl-Ludwig Noble and Hans-Georg Wussow: “Polyurethanes”, Ullmann's Encyclopedia of Industrial Chemistry Release 2005, Electronic Release, 7th ed., chap. 7 (“Foams”), Wiley-VCH, Weinheim 2005.

The envelope densities of the inventive polyurethane foams are preferably from 16 to 130 kg/m³. Their envelope densities are particularly preferably from 20 to 40 kg/m³.

The following starting components are used for production of the isocyanate-based foams:
1. Aliphatic, cycloaliphatic, araliphatic, aromatic and heterocyclic polyisocyanates (e.g. W. Siefken in Justus Liebigs Annalen der Chemie, 562, pp. 75-136), for example those of the formula Q(NCO)ₙ, in which n=from 2 to 4, preferably from 2 to 3, and Q is an aliphatic hydrocarbon radical having from 2 to 18, preferably from 6 to 10, carbon atoms, a cycloaliphatic hydrocarbon radical having from 4 to 15, preferably from 5 to 10, carbon atoms, an aromatic hydrocarbon radical having from 6 to 15, preferably from 6 to 13, carbon atoms, or an araliphatic hydrocarbon radical having from 8 to 15, preferably from 8 to 13, carbon atoms. Particular preference is generally given to the polyisocyanates which are readily accessible industrially and which derive from tolylene 2,4- and/or 2,6-diisocyanate or from diphenylmethane 4,4′- and/or 2,4′-diisocyanate.
2. Compounds having at least two hydrogen atoms reactive towards isocyanates and whose molar mass is from 400 to 8000 g/mol (“polyol component”). These are not only compounds having amino groups, thio groups or carboxy groups, but also preferably compounds having hydroxy groups, in particular compounds having from 2 to 8 hydroxy groups. If the polyurethane foam is intended to be a flexible foam, it is preferable to use polyols whose molar masses are from 2000 to 8000 g/mol and which have from 2 to 6 hydroxy groups per molecule. If, in contrast, the intention is to produce a rigid foam, it is preferable to use highly branched polyols whose molar masses are from 400 to 1000 g/mol and having from 2 to 8 hydroxy groups per molecule. The polyols are polyethers and polyesters and also polycarbonates and polyesteramides, as known for production of homogeneous and cellular polyurethanes and as described by way of example in DE-A 28 32 253. According to the invention, preference is given to polyesters and polyethers having at least two hydroxy groups.

The inventive polyurethane foams can therefore be produced in the form of rigid or flexible foams by selecting the starting materials appropriately in a manner easily found in the prior art.

Other starting components that can be used, if appropriate, are compounds having at least two hydrogen atoms reactive towards isocyanates and having a molecular weight of from 32 to 399. Here again, these are compounds having hydroxy groups and/or amino groups and/or thio groups and/or carboxy groups, preferably compounds having hydroxy groups and/or amino groups, which serve as chain extenders or crosslinking agents. These compounds generally have from 2 to 8, preferably from 2 to 4, hydrogen atoms reactive towards isocyanates. Examples here are likewise described in DE-A 28 32 253.
3. Water and/or volatile organic substances as blowing agent, e.g. n-pentane, isopentane, cyclopentane, halogen-containing alkanes, such as trichloromethane, methylene chloride or chlorofluoroalkanes, CO₂ and others.
4. If appropriate, concomitant use is made of auxiliaries and additives, such as catalysts of the type known per se, surfactant additives, such as emulsifiers and foam stabilizers, reaction retarders, e.g. substances having acidic reaction, e.g. hydrochloric acid or organic acid halides, and also cell regulators of the type known per se, e.g. paraffins or fatty alcohols and dimethylpolysiloxanes and also pigments or dyes and other flame retardants, and also stabilizers to counteract the effects of ageing and weathering, core-discoloration inhibitors, plasticizers and substances having fungistatic and bacteriostatic action and also fillers, such as barium sulphate, kieselguhr, carbon black or whiting (DE-A 27 32 292). Particular core-discoloration inhibitors that can be present are sterically hindered trialkylphenols, alkyl esters of 3-(3,5-di-tert-butyl-4-hydroxyphenyl)propionic acid, benzofuran-2-ones, secondary aromatic amines, phosphites, phenothiazines or tocopherols.

Other flame retardants which can be present alongside the tetraalkyl bisphosphates in the inventive polyurethane foams, if appropriate, are
a) organophosphorus compounds, such as triethyl phosphate, triphenyl phosphate, diphenyl cresyl phosphate, tricresyl phosphate, isopropylated or butylated aryl phosphates, aromatic bisphosphates, neopentyl glycol bis(diphenyl phosphate), chlorine-containing phosphoric esters, e.g. tris(chloroisopropyl)phosphate or tris(dichloropropyl)phosphate, dimethyl methanephosphonate, diethyl ethanephosphonate, dimethyl propanephosphonate, oligomeric phosphates or phosphonates, phosphorus compounds containing hydroxy groups, 5,5-dimethyl-1,3,2-dioxaphosphorinane 2-oxide derivatives,
b) inorganic phosphorus compounds, such as ammonium phosphate, ammonium polyphosphate, melamine phosphate, melamine polyphosphate,
c) nitrogen compounds, such as melamine, melamine cyanurate,
d) bromine compounds, such as alkyl esters of a tetrabromobenzoic acid, bromine-containing diols prepared from tetrabromophthalic anhydride, bromine-containing polyols, bromine-containing diphenyl ethers, or
e) inorganic flame retardants, such as aluminium hydroxide, boehmite, magnesium hydroxide, expandable graphite or clay minerals.

Other examples of materials to be used concomitantly according to the invention, if appropriate, in the form of surfactant additives and foam stabilizers and also cell regulators, reaction retarders, stabilizers, flame-retardant substances, plasticizers, dyes and fillers and also substances having fungistatic and/or bacteriostatic action are described in Kunststoff-Handbuch [Plastics handbook], Volume VII, Carl-Hanser-Verlag, Munich, 1993, on pages 104-123, as also are details concerning use of these additives and their mode of action.

The present invention also provides a process for production of flame-retardant polyurethane foams via reaction of organic polyisocyanates with compounds having at least two hydrogen atoms reactive towards isocyanates, and conventional blowing agents, stabilizers, catalysts, activators and/or other conventional auxiliaries and additives at from 20 to 80° C., characterized in that an amount of from 0.5 to 30 parts, based on 100 parts of polyol component, of halogen-free tetraalkyl biphosphates whose molar mass is at least 350 g/mol which are free from hydroxy groups are used as flame retardant.

In one preferred embodiment, the inventive process uses tetraalkyl bisphosphates of the general formula (I) 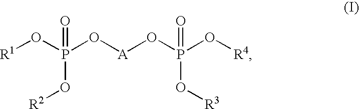
in which
R¹, R², R³, and R⁴, independently of one another, are a C₁-C₈-alkyl radical or C₁-C₄-alkoxyethyl radical,
A is a straight-chain, branched and/or cyclic C₄-C₂₀-alkylene radical, a —CH₂—CH═CH—CH₂-group, a —CH₂—C≡C—CH₂— group, or a —CHR⁵—CHR⁶—(O—CHR⁷—CHR⁸)ₐ— group, in which a is a number from 1 to 5, or a —CHR⁵—CHR⁶—S(O)_{b}—CHR⁷—CHR⁸— group, in which b is a number from 0 to 2, or a —(CHR⁵—CHR⁶)C—O—R⁹—O—(CHR⁷—CHR⁸)_{d}— group, in which c and d, independently of one another, are numbers from 1 to 5,
R⁵, R⁶, R⁷, and R⁸, independently of one another, are H or methyl,
R⁹ is a —CH₂—CH═CH—CH₂— group, a —CH₂—C≡C—CH₂— group, a 1,2-phenylene radical, a 1,3-phenylene radical, a 1,4-phenylene radical, a radical of the general formula (II), 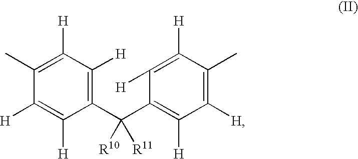
   or a radical of the general formula (III), 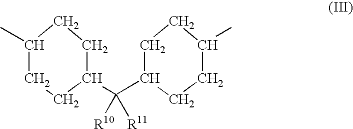
      or a radical of the general formula (IV), 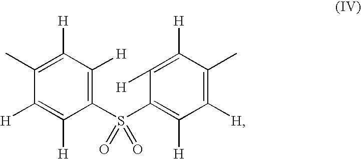
      or a radical of the formula —C(═O)—R¹²—C(═O)—,
R¹⁰ and R¹¹, independently of one another, are H or C₁-C₄-alkyl, or R¹⁰ and R¹¹ together are an optionally alkyl-substituted ring having from 4 to 8 carbon atoms, and
R¹² is a straight-chain, branched and/or cyclic C₂-C₈-alkylene radical, a 1,2-phenylene 5 radical, a 1,3-phenylene radical, or a 1,4-phenylene radical.

In another preferred embodiment, R¹, R², R³ and R⁴ are identical and are either ethyl, n-propyl, isopropyl, n-butyl or n-butoxyethyl.

In another preferred embodiment, A is a straight-chain C₄-C₆-alkylene radical or likewise a group of the general formula (III) 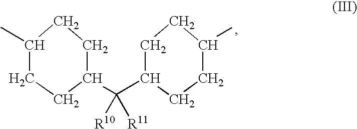
in which
R¹⁰ and R¹¹ are identical and are methyl, or a group of the formulae (V), (VI) or (VII), 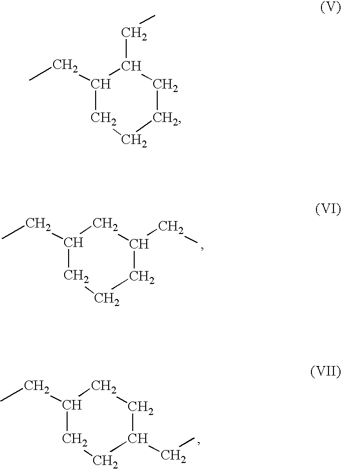
   or A is a —CHR⁵—CHR⁶—(O—CHR⁷—CHR⁸)ₐ— group, in which a is a number from 1 to 2 and R⁵, R⁶, R⁷ and R⁸ are identical and are H, or
A is a —(CHR⁵—CHR⁶)_{c}—O—R⁹—O—(CHR⁷—CHR⁸)_{d}— group, in which c and d, independently of one another, are a number from 1 to 2, R⁹ is a group of the general formula (II) and R¹⁰ and R¹¹ are identical and are methyl.

In particular, it is particularly preferable in the inventive process to use one or more of the tetraalkyl bisphosphates of the following specific formulae (VIII) to (XII).

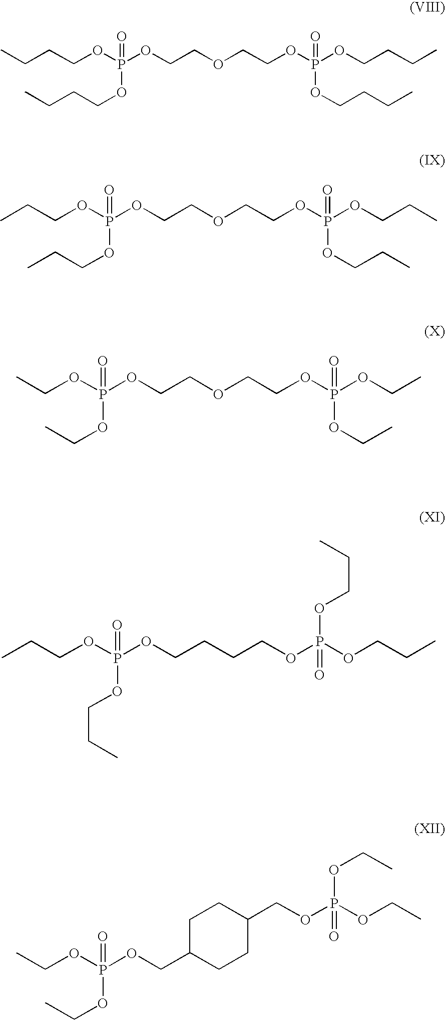

In the conduct of the process for production of the inventive polyurethane foams, the reaction components described above are reacted by the known single-stage process, by the prepolymer process or by the semi-prepolymer process, often using machinery, e.g. machinery described in U.S. Pat. No. 2,764,565. Details concerning processing equipment which can also be used according to the invention are described in Kunststoff-Handbuch [Plastics handbook] Volume VII, Polyurethane [Polyurethanes], edited by G. Oertel, Carl-Hanser-Verlag, Munich, Vienna 1993, on pages 139-192.

The inventive process can also produce cold-curing foams (GB Patent 11 62 517, DE-A 21 53 086). However, it is of course also possible to produce foams via slab foaming or via the known twin-belt process.

The polyisocyanurate foams are produced using the processes and conditions known for this purpose.

The inventive process permits production of flame-retardant polyurethane foams in the form of rigid or flexible foams by a continuous or batchwise production method or in the form of foamed mouldings. Preference is given to the inventive process in production of flexible foams produced via a slab foaming process.

Examples of applications of the products obtainable according to the invention are the following: furniture padding, textile inserts, mattresses, seats, preferably aircraft seats or automobile seats, armrests and modules, and also seat coverings and cladding over technical equipment.

The tetraalkyl bisphosphates present in the inventive polyurethane foams or used in the inventive process are either known or can be produced by known methods. The starting materials used here are available on an industrial scale and permit easy production of the desired final products.

U.S. Pat. No. 4,056,480, examples 1 and 2, column 7, lines 4-38, describe the preparation of the compound (VIII) diethylene glycol bis(di-n-butyl phosphate), molar mass 491 g/mol, CAS reg. No. 62955-03-7, from diethylene glycol, phosphorus oxychloride and n-butanol.

U.S. Pat. No. 2,782,128, example 1, column 2, line 47-column 3, line 21, describes the preparation of the compound (IX) diethylene glycol bis(di-n-propyl phosphate), molar mass 434 g/mol, CAS reg. No. 109598-814, from diethylene glycol, phosphorus trichloride, chlorine and n-propanol.

The compound (X) diethylene glycol bis(diethyl phosphate), molar mass 378 g/mol, CAS reg. No. 500347-73-9, can be prepared by the process stated in U.S. Pat. No. 4,056,480 for preparation of the compound (VIII), using diethylene glycol, phosphorus oxychloride and ethanol.

U.S. Pat. No. 2,782,128, example 3, column 3, line 35-column 4, line 3, describes the preparation of the compound (XI) 1,4-butanediol bis(di-n-propyl phosphate), molar mass 418 g/mol, CAS reg. No. 10944143-2, from 1,4-butanediol, phosphorus trichloride, chlorine and n-propanol.

The compound (XII) 1,4-cyclohexanedimethanol bis(diethyl phosphate), molar mass 416 g/mol, can be prepared by the process stated in U.S. Pat. No. 4,056,480, column 8, lines 5-39 for preparation of 1,4-cyclohexanedimethanol bis(di-n-butyl phosphate), CAS reg. No. 62955-05-9, using 1,4-cyclohexanedimethanol, phosphorus oxychloride and ethanol.

The liquid tetraalkyl bisphosphates are easy to meter. They do not react with the other starting materials used for the production of the polyurethane foams and are therefore very easy to process as additives. Surprisingly, use of the tetraalkyl bisphosphates can give foams which not only meet the requirements for flame retardancy but also exhibit particularly low fogging values.

The examples below provide further illustration of the invention, but there is no intention of restricting the invention thereby.

### EXAMPLES

Flexible Polyurethane Foam

The parts stated are based on weight.

Materials Used

| Component | Function | Description |
|---|---|---|
| A | Polyol | Arcol ® 1105 (Bayer MaterialScience), |
| | | Polyether polyol whose OH number is 56 mg KOH/g |
| B | Blowing agent | Water |
| C | Catalyst | Niax ® A-1 (GE Silicones), 70% strength solution of |
| | | bis(2-dimethylaminoethyl) ether in dipropylene glycol |
| D | Catalyst | Desmorapid ® SO (Rheinchemie), stannous 2-ethylhexanoate |
| E | Stabilizer | Tegostab ® B 8232 (Degussa), silicone stabilizer |
| F1 | Flame retardant | Tris(chloroisopropyl) phosphate, TCPP, |
| | | CAS reg. no. 13674-84-5 |
| F2 | Flame retardant | Tris(2,3-dichloroisopropyl) phosphate, TDCP, |
| | | CAS Reg. no. 13674-87-8 |
| F3 | Flame retardant | Diphenyl cresyl phosphate, CAS reg. No. 26444-49-5 |
| F4 | Flame retardant | Diethylene glycol bis(diethyl phosphate), formula X, |
| | | CAS reg. no. 500347-73-9 |
| G | Diisocyanate | Desmodur ® T 80 (Bayer MaterialScience), |
| | | tolylene diisocyanate, isomer mixture |

Production of Flexible Polyurethane Foams

The components whose nature and amount is stated in table 1, with the exception of the diisocyanate (component G) were mixed to give a homogeneous mixture. The diisocyanate was then added and incorporated by brief and intensive stirring. After a cream time of from 15 to 20 s and a full rise time of from 200 to 220 s, the product was a flexible polyurethane foam whose envelope density was 33 kg/m³.

Determination of Flame Retardancy

The flexible polyurethane foams were tested to the specifications of the Federal Motor Vehicle Safety Standard FMVSS 302, and allocated to fire classes SE (self-extinguishing), SE/NBR (self-extinguishing/no burn rate), SE/B (self-extinguishing/with burn rate), BR (burn rate) and RB (rapid burning). For each example, the fire tests were carried out five times. Table 1 gives the porest result of each series of five.

Determination of Fogging

The fogging behaviour of the flexible polyurethane foams was studied to DIN 75201 B. Table 1 gives the amounts of condensate measured.

TABLE 1
Constitution (parts) and test results for inventive example IE1 and for
non-inventive comparative examples CE1-CE4

| Example | | | | |
|---|---|---|---|---|
| CE1 | CE2 | CE3 | CE4 | IE1 |

| | | | | | |
|---|---|---|---|---|---|
| A | 100 | 100 | 100 | 100 | 100 |
| B | 3.0 | 3.0 | 3.0 | 3.0 | 3.0 |
| C | 0.10 | 0.10 | 0.10 | 0.10 | 0.10 |
| D | 0.13 | 0.13 | 0.13 | 0.13 | 0.13 |
| E | 0.80 | 0.80 | 0.80 | 0.80 | 0.80 |
| F1 | | 6 | | | |
| F2 | | | 6 | | |
| F3 | | | | 6 | |
| F4 | | | | | 6 |
| G | 40.9 | 40.9 | 40.9 | 40.9 | 40.9 |
| MVSS class | RB | not | SE | BR | SE |
| | | determined | | | |
| Fogging | 0.3 | 17.8 | 0.8 | 0.8 | 0.8 |
| condensate [mg] | | | | | |
| to | | | | | |
| DIN 75201 B | | | | | |

Results

In the absence of any flame retardant (comparative example CE1), the flexible polyurethane foam is rapidly consumed by combustion, but exhibits a very low fogging value. Modification with the frequently used flame retardant tris(chloroisopropyl)phosphate (comparative example CE2) lead to greatly increased fogging. A foam using tris(2,3-dichloroisopropyl)phosphate (comparative example CE3) complies with the fogging value required by the automobile industry of at most 1 mg of condensate and can achieve the best fire class SE (self-extinguishing) in all of the repeats of the fire test. However, tris(2,3-dichloroisopropyl)phosphate is associated with the disadvantages described above of a halogen-containing flame retardant. Although use of the halogen-free flame retardant diphenyl cresyl phosphate (comparative example CE4) overcomes this problem and also achieves a low fogging value, flame retardancy is inadequate. Inventive example 1 shows that the inventive, halogen-free flexible polyurethane foams feature the best fire class SE (self-extinguishing) in all of the repeats of the fire test, and feature a very low fogging value.

Rigid Polyurethane Foam

The parts stated are based on weight.

Materials Used

| Component | Function | Description |
|---|---|---|
| A | Polyol | Stepanol ® PS-2352 (Stepan), |
| | | Polyester polyol whose OH number is 240 mg KOH/g |
| B | Blowing agent | Water |
| C | Blowing agent | n-pentane |
| D | Catalyst | DABCO ® K-15 (Air Products), potassium octoate formulation |
| E | Catalyst | DABCO ® 2097 (Air Products), potassium acetate formulation |
| G | Catalyst | Polycat ® 5 (Air Products), pentamethyldiethylenetriamine |
| H | Stabilizer | DABCO ® DC-5598 (Air Products), silicone stabilizer |
| I | Diisocyanate | Desmodur ® 44 V 40 L (Bayer MaterialScience), polymeric |
| | | diphenylmethane diisocyanate, isocyanate content: 31.5% by |
| | | weight |
| F1 | Flame retardant | Tris(chloroisopropyl) phosphate, TCPP, |
| | | CAS reg. no. 13674-84-5 |
| F2 | Flame retardant | Triethyl phosphate, TEP, |
| | | CAS reg. no. 78-40-0 |
| F3 | Flame retardant | Diethylene glycol bis(diethyl phosphate), formula X, |
| | | CAS reg. no. 500347-73-9 |

Production of Rigid Polyurethane Foams

The components whose nature and amount is stated in table 2, with the exception of the diisocyanate (component I) were mixed to give a homogeneous mixture. The diisocyanate was then added and incorporated by brief and intensive stirring. After a cream time of from 10 to 15 s and a full rise time of from 40 to 50 s, the product was a flexible polyurethane foam whose envelope density was 28 kg/m³.

Determination of Flame Retardancy

The rigid polyurethane foams were tested to the specifications of DIN 4102-1 and allocated to fire classes B2 (normal flammability) or B3 (high flammability). The flame height in this small burner test is determined with 15 s of flame application. It is a measure of the effectivity of a flame retardant.

TABLE 2
Constitution (parts) and test results for inventive example IE2 and for non-
inventive comparative examples CE5-CE6

| | Example | | |
|---|---|---|---|
| | CE5 | CE6 | IE2 |
| A | 100 | 100 | 100 |
| B | 0.5 | 0.5 | 0.5 |
| C | 24.3 | 24.3 | 24.3 |
| D | 1.9 | 1.9 | 1.9 |
| E | 0.35 | 0.35 | 0.35 |
| G | 0.25 | 0.25 | 0.25 |
| H | 2.5 | 2.5 | 2.5 |
| I | 205 | 205 | 205 |
| F1 | 25 | | |
| F2 | | 25 | |
| F3 | | | 25 |
| DIN 4102-1 class | B2 | B3 | B2 |
| Average flame height | 143 | 146 | 125 |
| [mm] | | | |

Results

The experiments show that B2 classification is achieved using the halogen-containing flame retardant TCPP (comparative example CE5), whereas using the same amount of the halogen-free flame retardant TEP (comparative example CE6) only classification B3 can be achieved. In contrast, example IE2 using the inventive halogen-free flame retardant achieves classification B2 with smaller average flame height than comparative example 1 using the halogen-containing flame retardant TCPP.

What is claimed is:

1. A flame-retardant polyurethane foam comprising, as flame retardant halogen-free tetraalkyl bisphosphates being free from hydoxy groups and having molar mass at least 350 g/mol.

2. A flame-retardant polyurethane foam according to claim 1, having, as flame retardant a halogen-free tetraalkyl bisphosphate of the general formula (I) having being free from hydroxy groups 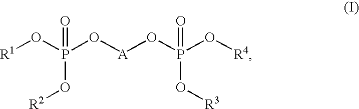
wherein
R¹, R², R³, and R⁴, independently of one another, are a C₁-C₈-alkyl radical or C₁-C₄-alkoxyethyl radical,
A is a straight-chain, branched and/or cyclic C₄-C₂₀-alkylene radical, a —CH₂—CH═CH—CH₂— group, a —CH₂—C≡C—CH₂— group, or a —CHR⁵—CHR⁶—(O—CHR⁷—CHR⁸)ₐ— group, in which a is a number from 1 to 5, or a —CHR⁵—CHR⁶—S(O)_{b}—CHR⁷—CHR⁸— group, in which b is a number from 0 to 2, or a —(CHR⁵—CHR⁶)_{c}—O—R⁹—O—(CHR⁷—CHR⁸)_{d}— group, in which c and d, independently of one another, are numbers from 1 to 5,
R⁵, R⁶, R⁷, and R⁸, independently of one another, are H or methyl,
R⁹ is a —CH₂—CH═CH—CH₂— group, a —CH₂—C≡C—CH₂— group, a 1,2-phenylene radical, a 1,3-phenylene radical, a 1,4-phenylene radical, a radical of the general formula (II), 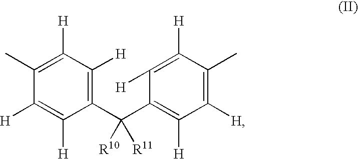
or a radical of the general formula (III), 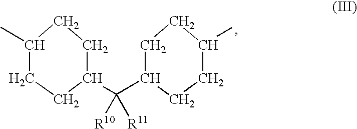
or a radical of the general formula (IV), 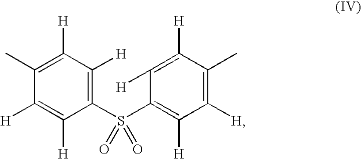
or a radical of the formula —(═O)—R¹²—C(═O)—,
R¹⁰ and R¹¹, independently of one another, are H or C₁-C₄-alkyl, or R¹⁰ and R¹¹ together are an optionally alkyl-substituted ring having from 4 to 8 carbon atoms, and
R¹² is a straight-chain, branched and/or cyclic C₂-C₈-alkylene radical, a 1,2-phenylene radical, a 1,3-phenylene radical, or a 1,4-phenylene radical.

3. A flame-retardant polyurethane foam according to claim 2, wherein A is a straight-chain C₄-C₆-alkylene radical, a group of the formula (VII), 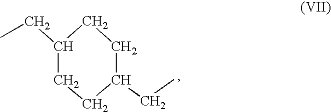
or a-CHR⁵—CHR⁶—(O—CHR⁷—CHR⁸)ₐ— group, in which a is a number from 1 to 3, and R⁵, R⁶, R⁷ and R⁸ are all H.

4. A flame-retardant polyurethane foam according to one of claims 1 to 3, wherein the tetraalkyl bisphosphates are diethylene glycol bis(di-n-butyl phosphate), diethylene glycol bis(di-n-propyl phosphate), diethylene glycol bis(diethyl phosphate), 1,4-butanediol bis(di-n-propyl phosphate), or 1,4-cyclohexanedimethanol bis(diethyl phosphate).

5. A flame-retardant polyurethane foam according to one of claims 1 to 4, wherein other known flame retardants are used alongside the tetraalkyl bisphosphates.

6. A flame-retardant polyurethane foam according to one of claims 1 to 5, wherein these are flexible foams or rigid foams.

7. A process for production of flame-retardant polyurethane foams via reaction of organic polyisocyanates with compounds having at least two hydrogen atoms reactive towards isocyanates, and conventional blowing agents, stabilizers, activators and/or other conventional auxiliaries and additives at from 20 to 80° C., wherein an amount of from 0.5 to 30 parts, based on 100 parts of a polyol component, of a halogen-free tetraalkyl biphosphate with a molar mass at least at 350 g/mol and being free from hydroxy groups used as flame retardant.

8. A method of use of the polyurethane foam according to claim 1 in furniture padding, in textile inserts, in mattresses, in seats, in armrests, in modules, and also in seat coverings and cladding over technical equipment.
